(19) United States
(12) Patent Application Publication
(10) Pub. No.: US 2024/0354582 A1
(43) Pub. Date: Oct. 24, 2024

(54) METHOD FOR CONTRASTIVE LEARNING FOR AUTOMATIC LABELING OF DATA AND APPARATUS USING THE SAME

(71) Applicant: ELECTRONICS AND TELECOMMUNICATIONS RESEARCH INSTITUTE, Daejeon (KR)

(72) Inventors: Seon-Tae KIM, Daejeon (KR); Joon-Sun AUH, Daejeon (KR); Chang-Sik CHO, Daejeon (KR)

(21) Appl. No.: 18/441,076

(22) Filed: Feb. 14, 2024

(30) Foreign Application Priority Data
Apr. 24, 2023 (KR) 10-2023-0053239

(51) Int. Cl. G06N 3/0895

(52) U.S. Cl. CPC G06N 3/0895

(57) ABSTRACT

Disclosed herein are a method for contrastive learning of a neural network for automatic data labeling and an apparatus for the same. The method includes generating transformed data samples for unlabeled input data samples corresponding to a batch size, detecting a positive sample (positive data) in the transformed data samples in consideration of the similarity between a single data sample for contrastive learning, among the input data samples, and each of the transformed data samples, and performing contrastive learning of a neural network based on the loss value of the positive sample.

### CROSS REFERENCE TO RELATED APPLICATION

This application claims the benefit of Korean Patent Application No. 10-2023-0053239, filed Apr. 24, 2023, which is hereby incorporated by reference in its entirety into this application.

### BACKGROUND OF THE INVENTION

### 1. Technical Field

The present disclosure relates generally to technology for contrastive learning of a neural network for automatic data labeling, and more particularly to contrastive learning technology for discovering features of large-scale data, grouping the large-scale data by similar features, and training a neural network based thereon.

### 2. Description of Related Art

In Artificial Intelligence (AI), data processing is the most time-consuming and costly part and requires human intervention. However, as AI neural networks became deeper and the amount of data required to be processed increased, self-supervised learning technology through which features of large-scale data can be discovered and represented without human intervention has been developed. Contrastive learning, which is one of methods for data representations in self-supervised learning, is a data classification technique for representing diverse properties of data through a mechanism in which data transformed from anchor data is brought closer but data transformed from data other than that is pushed apart by considering the same as a different representation.

In the existing contrastive learning, the output value of a neural network for data transformed from anchor data is represented as belonging to the same category as the anchor data, because there is no information about a classification system for the anchor data. Also, loss is calculated by representing the other data samples as belonging to a different category, and the weight values of the neural network may be updated based thereon. Here, when two pieces of transformed data generated for a single piece of input data are respectively input to neural networks of the same structure, the results output therefrom are predicted to be the same representations. Conversely, the other pieces of input data in the same set are predicted to be different representations. Through such prediction, data classification is performed such that the same data is brought closer and different data is pushed away, and an algorithm based on this technique is referred to as contrastive learning and is applied to automated data labeling.

However, a single dataset corresponding to a batch size, which is set for updating a neural network, may contain different pieces of data that have to be regarded as of the same type, but the existing method cannot consider this case.

### DOCUMENTS OF RELATED ART

(Patent Document 1) Korean Patent Application Publication No. 10-2022-0148734, published on Nov. 7, 2022 and titled “Apparatus and method for searching for task-adaptive neural network based on meta contrastive learning”.

### SUMMARY OF THE INVENTION

An object of the present disclosure is to calculate a loss value by reflecting not only a data sample generated from an anchor sample but also a similar data sample belonging to the same kind of class as the anchor sample, thereby improving accuracy when a neural network is updated.

Another object of the present disclosure is to improve the prediction accuracy of a neural network through more accurate revision thereof.

A further object of the present disclosure is to calculate a loss value by considering similar data belonging to the same kind of class as an anchor sample as positive data, thereby performing more accurate update of a neural network.

In order to accomplish the above objects, a method for contrastive learning of a neural network for automatic data labeling according to the present disclosure includes generating transformed data samples for unlabeled input data samples corresponding to a batch size, detecting a positive sample (positive data) in the transformed data samples in consideration of the similarity between a single data sample for contrastive learning, among the input data samples, and each of the transformed data samples, and performing contrastive learning of a neural network based on a loss value of the positive sample.

Here, a transformed data sample, the cosine similarity of which with the single data sample is equal to or greater than a preset reference value, may be detected as the positive sample.

Here, the positive sample may include a transformed data sample belonging to the same kind of class as the single data sample depending on the cosine similarity.

Here, a transformed data sample belonging to the same kind of class as the single data sample and having the cosine similarity equal to or greater than the preset reference value may be classified as the positive sample.

Here, when a data sample is a transformed data sample for the single data sample but has the cosine similarity less than the preset reference value, the data sample may be classified as a negative sample (negative data).

Here, the lower the preset reference value for the cosine similarity, the more the positive samples that are detected, and the higher the preset reference value for the cosine similarity, the less the positive samples that are detected.

Here, a total loss value may be calculated based on the loss value of the positive sample, and the neural network may be updated by setting weights of the neural network so as to minimize the total loss value.

Also, an apparatus for contrastive learning of a neural network for automatic data labeling according to an embodiment of the present disclosure includes a processor for generating transformed data samples for unlabeled input data samples corresponding to a batch size, detecting a positive sample (positive data) in the transformed data samples in consideration of the similarity between a single data sample for contrastive learning, among the input data samples, and each of the transformed data samples, and performing contrastive learning of a neural network based on a loss value of the positive sample; and memory for storing the neural network.

Here, the processor may detect a transformed data sample, the cosine similarity of which with the single data sample is equal to or greater than a preset reference value, as the positive sample.

Here, the positive sample may include a transformed data sample belonging to the same kind of class as the single data sample depending on the cosine similarity.

Here, the processor may classify a transformed data sample belonging to the same kind of class as the single data sample and having the cosine similarity equal to or greater than the preset reference value as the positive sample.

Here, when a data sample is a transformed data sample for the single data sample but has the cosine similarity less than the preset reference value, the processor may classify the data sample as a negative sample (negative data).

Here, the lower the preset reference value for the cosine similarity, the more the positive samples that are detected, and the higher the preset reference value for the cosine similarity, the less the positive samples that are detected.

Here, the processor may calculate a total loss value based on the loss value of the positive sample and update the neural network by setting weights of the neural network so as to minimize the total loss value.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for contrastive learning of a neural network for automatic data labeling according to an embodiment of the present disclosure;

FIG. 2 is a view illustrating an example of unlabeled samples of a dataset;

FIG. 3 is a view illustrating an existing data comparison method;

FIG. 4 is a view illustrating a data comparison method according to the present disclosure;

FIG. 5 is a flowchart illustrating an existing method for contrastive learning of a neural network in detail;

FIG. 6 is a flowchart illustrating in detail a method for contrastive learning of a neural network for automatic data labeling according to the present disclosure when compared with FIG. 5; and

FIG. 7 is a view illustrating an apparatus for contrastive learning of a neural network for automatic data labeling according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

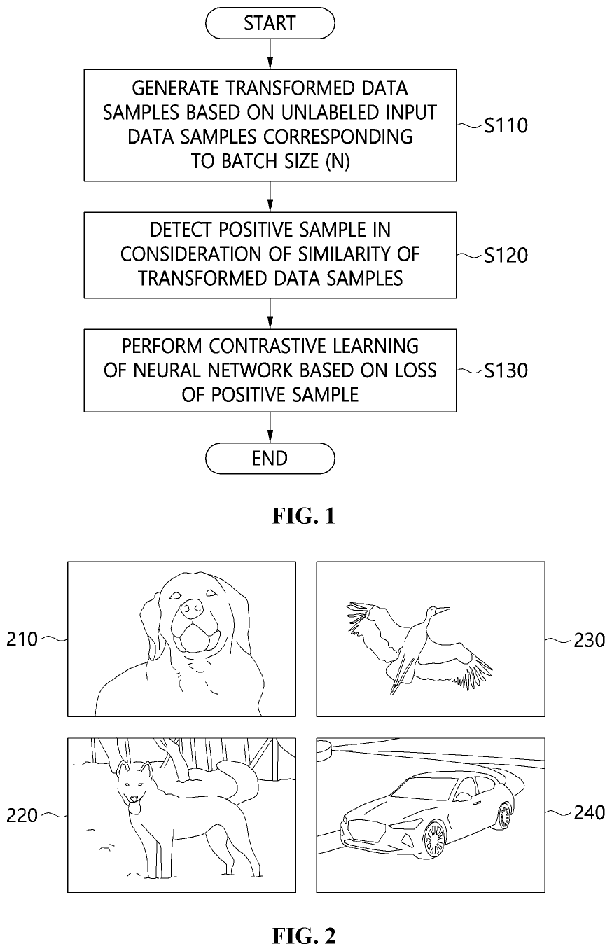

FIG. 1 is a flowchart illustrating a method for contrastive learning of a neural network for automatic data labeling according to an embodiment of the present disclosure.

Referring to FIG. 1, in the method for contrastive learning of a neural network for automatic data labeling according to an embodiment of the present disclosure, transformed data samples are generated for unlabeled input data samples corresponding to a batch size at step S110.

Generally in contrastive learning, a neural network to be trained is completed by updating weights of the neural network based on the loss value between data similar to an anchor sample (a positive sample) and data having characteristics different from those of the anchor sample (a negative sample). That is, the similar data is pulled such that the position of the feature value comes close, but the dissimilar data is pushed such that the position of the vector of the feature value becomes farther away.

For example, because a neural network for contrastive learning is trained with unlabeled data samples 210, 220, 230, and 240, as shown in FIG. 2, it is difficult to find positive data. Therefore, the existing contrastive learning method sets only the feature values of transformed data samples 211 and 212 generated for the anchor sample 210 as positive data (positive samples) and sets all of the other transformed data samples 221, 222, 231, 232, 241, and 242 as negative data (negative samples). Here, it can be seen that the transformed data samples 221 and 222 generated for the same class as the anchor sample 210 are also set as negative data (negative samples).

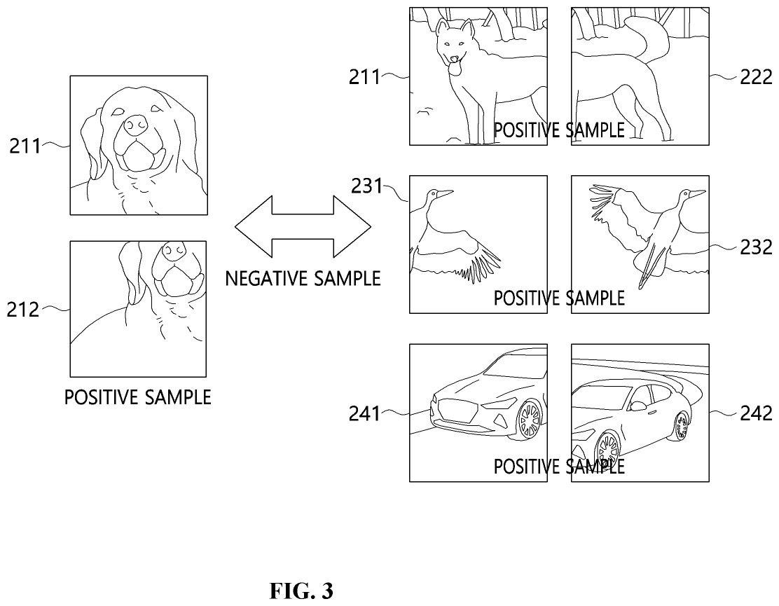

Also, a batch size, which is the size of a batch that is a unit of data processing, may be set large in order to improve the performance of contrastive learning, but when the batch size is set large, the batch may include a large number of data samples belonging to the same class as an anchor sample. However, in the existing contrastive learning method, neural network training is performed by calculating loss by considering such data samples of the same class (the transformed data samples 221 and 222 in the same class as the anchor sample 210) in the batch as belonging to a different class, as illustrated in FIG. 3.

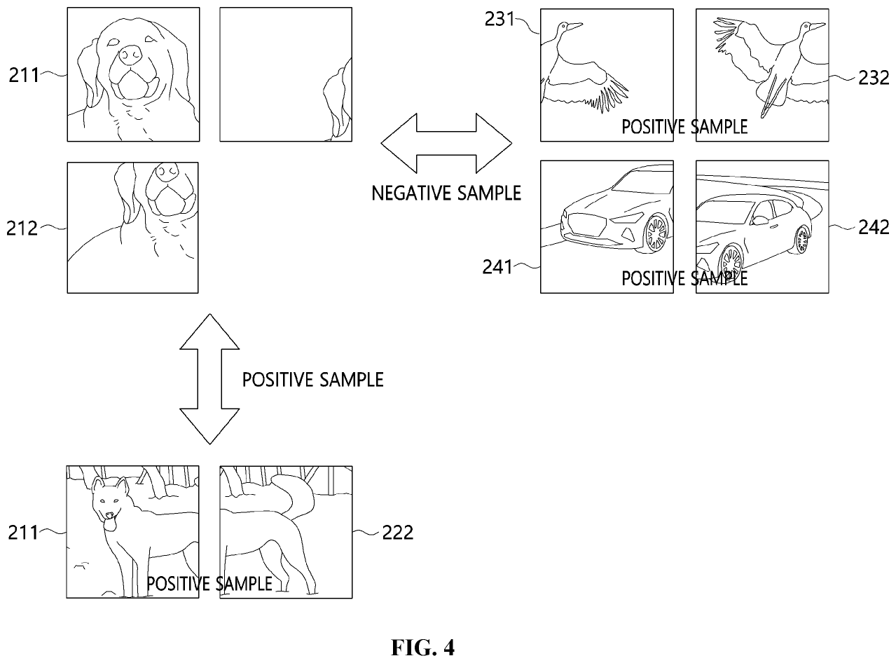

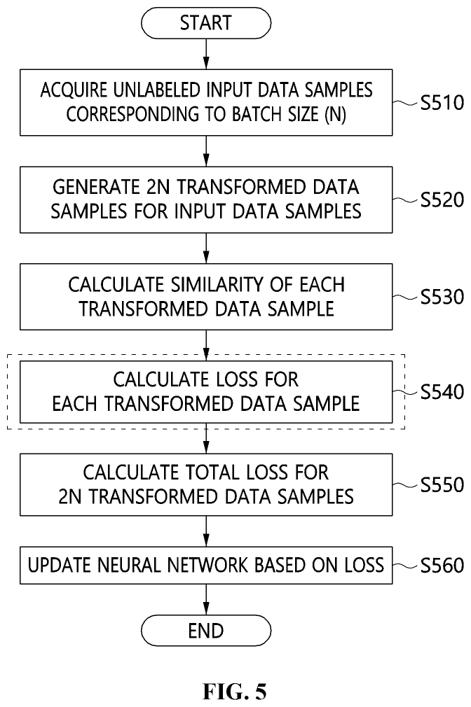

The present disclosure proposes a contrastive learning method that performs neural network learning by effectively extracting data of the same class as positive data (a positive sample), as illustrated in FIG. 4, and a specific method for applying the correlation between a relevant parameter and an additional parameter generated in this process will be described below.

Here, in contrastive learning, neural network parameters are set by performing repeated learning 300 to 1000 times (epochs) for a training dataset. Here, because a training dataset for each epoch typically has a huge size and is difficult to process in one go, it is divided into multiple batches, which are the units of neural network training, so as to be processed multiple times.

Also, in the method for contrastive learning of a neural network for automatic data labeling according to an embodiment of the present disclosure, a positive sample (positive data) is detected in the transformed data samples in consideration of the similarity between a single data sample for contrastive learning, among the input data samples, and each of the transformed data samples at step S120.

Here, a transformed data sample, the cosine similarity of which with the single data sample is equal to or greater than a preset reference value, may be detected as the positive sample.

Here, the positive sample may also include a transformed data sample belonging to the same kind of class as the single data sample depending on the cosine similarity.

Here, a transformed data sample belonging to the same kind of class as the single data sample and having the cosine similarity equal to or greater than the preset reference value may be classified as a positive sample.

Here, when a data sample is a transformed data sample for the single data sample but has cosine similarity less than the preset reference value, the data sample may be classified as a negative sample (negative data).

For example, data transformation may be performed by cropping a large image into small parts, as illustrated in FIG. 3 and FIG. 4. In the existing contrastive learning method, all of the samples cropped from a single image are regarded as positive samples, so there is a problem in which a data sample having low similarity, like the transformed image 213 illustrated in FIG. 4, is also detected as a positive sample. Also, although the unlabeled data samples 210 and 220 in FIG. 2 are images for the same class (DOG), they are not transformed data samples generated from the same image, so all of the transformed data samples 221 and 222 are regarded as negative samples, as illustrated in FIG. 3.

Considering this situation, the present disclosure detects positive samples based on cosine similarity such that the transformed data samples 221 and 222 illustrated in FIG. 3 are detected as positive samples but the transformed data sample 213 illustrated in FIG. 3 is not detected as a positive sample.

Here, the lower the preset reference value for the cosine similarity, the more the positive samples that are detected, and the higher the preset reference value for the cosine similarity, the less the positive samples that are detected.

For example, the cosine similarity is the inner product of two vectors, and as the value thereof is closer to 1, the cosine similarity is determined to be higher, in which case the angle θ between the two vectors has a value close to 0. Accordingly, when the cosine similarity between two data samples transformed from a single data sample is calculated, the cosine similarity between the transformed data samples 211 and 212 illustrated in FIG. 3 may have a value close to 1. However, the cosine similarity between the transformed data samples 211 and 213 illustrated in FIG. 4 may have a relatively low cosine similarity value (e.g., 0.2).

Here, because data samples having features of a class corresponding to ‘DOG’, like the transformed data samples 211 and 212, have high cosine similarity, it may be determined that all of the two transformed data samples belong to the ‘DOG’ class. Accordingly, the cosine similarity is calculated also for the data samples 221, 222, 231, 232, 241, and 242, which are transformed from different data samples, and all of the transformed data samples, the cosine similarity of which satisfies the preset reference value (e.g., 0.98, θ=10), may be detected as positive samples.

That is, in the present disclosure, the range of positive data is set to each class for data classification, rather than being limited to each data sample, whereby positive data may be more clearly determined.

Here, the angle θ between the two vectors, which is a derived parameter, may be used as an important factor for determining how close two pieces of data are. According to an embodiment of the present disclosure, high performance is achieved when the cosine similarity is 0.97 (θ=13).

Also, in the method for contrastive learning of a neural network for automatic data labeling according to an embodiment of the present disclosure, contrastive learning of a neural network is performed based on the loss value of the positive sample at step S130.

Here, a total loss value is calculated based on the loss value of the positive sample, and the weights of the neural network are set such that the total loss value is minimized, whereby the neural network may be updated.

Here, the loss value of the positive sample may be calculated as shown in Equation (1) below:

$$\text{?} = - \text{?} \frac{1}{P ( i )} {\sum }_{j ∈ P ( i )} log \frac{exp ( cos im ( {z}_{i} , {z}_{j} ) / τ )}{{\sum }_{k \neq j}^{2 ( N - 1 )} exp ( cos im ( {z}_{i} , {z}_{k} ) / τ )} \qquad ( 1 )$$

$$\text{?} \text{indicates text missing or illegible when filed}$$

Here, I is the number of transformed data samples, which is 2N, and P(i) is the number of samples that are determined to be positive samples based on cosine similarity. Also, k may indicate all of data samples, excluding positive samples transformed from an anchor sample in the transformed data samples, and the number thereof may be 2 (N−1). Also, t indicates the sensitivity when two pieces of data push or attract each other, and when t is close to 1, this may indicate that the sensitivity is low, but when t is close to 0, this may indicate that the sensitivity is high.

Here, according to the present disclosure, it is necessary to consider a change caused due to t because multiple positive samples can be included.

For example, the number of detected positive samples decreases as the reference value for the cosine similarity for determining positive samples is higher, and the number of detected positive samples increases as the reference value for the cosine similarity is lower. Therefore, it is necessary to set the correlation between the above-described angle θ between two vectors and t, which indicates the sensitivity when the two pieces of data are brought closer together or pushed farther apart, as an important parameter affecting the positive sample detection performance and to adjust the value thereof to a suitable value for performance improvement.

Through the above-described method for contrastive learning of a neural network for automatic data labeling, positive samples are more clearly determined. Accordingly, performance may be improved compared to the existing contrastive learning method, and this method may be applied to applications for automatic data labeling.

Also, the present disclosure may improve the prediction accuracy of a neural network through more accurate revision thereof.

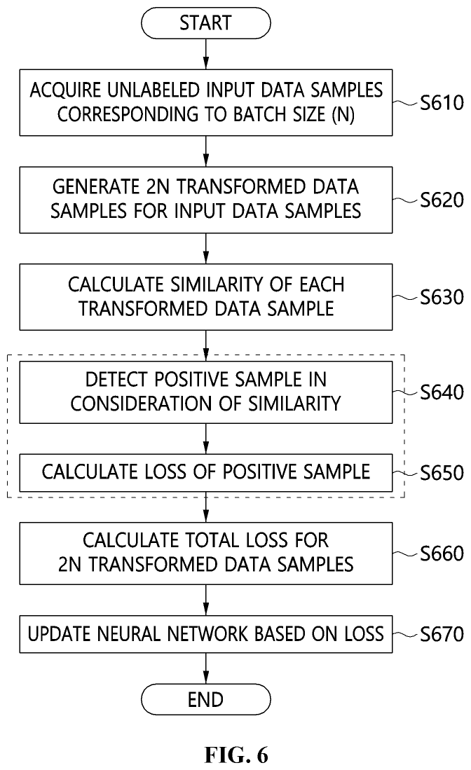

FIG. 5 is a flowchart illustrating an existing method for contrastive learning of a neural network in detail, and FIG. 6 a flowchart illustrating in detail a method for contrastive learning of a neural network for automatic data labeling according to the present disclosure when compared with FIG. 5.

First, the flowchart illustrated in FIG. 5 relates to a process that is performed when input data corresponding to a batch size is input, and steps S510 to S560 may be repeatedly performed. Here, the number of times steps S510 to S560 are repeatedly performed may correspond to <the size of a training dataset/a batch size*the number of times repeated learning is performed>.

Also, because contrastive learning requires clustering of data samples having similar features by extracting data features from unlabeled data samples, huge amounts of training data are required, and ImageNet is commonly used. Here, because ImageNet includes 1.28 million images classified into 1000 classes, when a batch size is set to 256, contrastive learning may be performed by taking 5000 iterations by dividing 1.28 million images into batches having a size of 256. Also, assuming that the number of times repeated learning is performed is 300, 5000 iterations of the learning process have to be repeated 300 times. Therefore, steps S510 to S560 may be repeatedly performed a total of 1,500,000 times (300×5000=1,500,000).

Referring to FIG. 5, when unlabeled data samples are input in units of batches, each having a size of N, at step S510, 2N transformed data samples may be generated at step S520 by randomly cropping different parts of each of the images corresponding to the input data samples.

Subsequently, cosine similarity may be calculated for the 2N transformed data samples at step S530.

Subsequently, the partial loss for each transformed data sample may be calculated as an entropy value at step S540 by reflecting the cosine similarity value from a positive sample in a numerator and reflecting the cosine similarity value from a negative sample in a denominator.

Subsequently, a total loss value for the 2N transformed data samples is calculated at step S550, and a neural network may be updated so as to minimize the calculated total loss value at step S560.

However, because the existing method updates the neural network by calculating the loss on the assumption that, among the input data samples corresponding to the batch size (N), only one data sample is a positive sample, as described above, the transformed data samples 211 and 222 of the same kind of class that are input in the same batch are not classified as positive samples, as illustrated in FIG. 3. Particularly, when the batch size is greater than the size of a class, there is a probability that two or more positive samples are present in the same batch.

Accordingly, considering this situation, the present disclosure proposes a method that replaces step S540 illustrated in FIG. 5 with steps S640 and S650 illustrated in FIG. 6 in order to detect positive samples.

That is, referring to steps S640 and S650 in FIG. 6, the similarity of each of the transformed data samples within a batch is considered, and the transformed data sample, the similarity of which is greater than a preset reference value, is detected as a positive sample at step S640, and partial loss may be calculated for the detected positive sample at step S650.

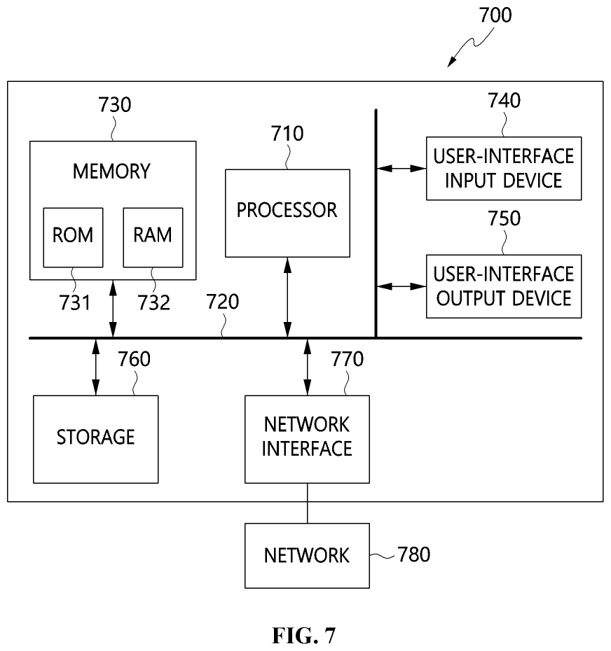

FIG. 7 is a view illustrating an apparatus for contrastive learning of a neural network for automatic data labeling according to an embodiment of the present disclosure.

Referring to FIG. 7, the apparatus for contrastive learning of a neural network for automatic data labeling according to an embodiment of the present disclosure may be implemented in a computer system including a computer-readable recording medium. As illustrated in FIG. 7, the computer system 700 may include one or more processors 710, memory 730, a user-interface input device 740, a user-interface output device 750, and storage 760, which communicate with each other via a bus 720. Also, the computer system 700 may further include a network interface 770 connected to a network 780. The processor 710 may be a central processing unit or a semiconductor device for executing processing instructions stored in the memory 730 or the storage 760. The memory 730 and the storage 760 may be any of various types of volatile or nonvolatile storage media. For example, the memory may include ROM 731 or RAM 732.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

The processor 710 generates transformed data samples for unlabeled input data samples corresponding to a batch size.

Also, the processor 710 detects a positive sample (positive data) in the transformed data samples in consideration of the similarity between a single data sample for contrastive learning, among the input data samples, and each of the transformed data samples.

Here, a transformed data sample, the cosine similarity of which with the single data sample is equal to or greater than a preset reference value, may be detected as a positive sample.

Here, the positive sample may also include a transformed data sample belonging to the same kind of class as the single data sample depending on the cosine similarity.

Here, a transformed data sample belonging to the same kind of class as the single data sample and having cosine similarity equal to or greater than the preset reference value may be classified as a positive sample.

Here, when a data sample is a transformed data sample for the single data sample but has cosine similarity less than the preset reference value, the data sample may be classified as a negative sample (negative data).

Here, the lower the preset reference value for the cosine similarity, the more the positive data samples that are detected, but the higher the preset reference value for the cosine similarity, the less the positive data samples that are detected.

Also, the processor 710 performs contrastive learning of a neural network based on a loss value of the positive sample.

Here, a total loss value is calculated based on the loss value of the positive sample, and the neural network may be updated by setting the weights of the neural network so as to minimize the total loss value.

The memory 730 stores the neural network.

Using the above-described apparatus for contrastive learning of a neural network for automatic data labeling, not only a data sample generated from an anchor sample but also a similar data sample belonging to the same kind of class as the anchor sample are reflected in calculation of a loss value, whereby accuracy may be improved when a neural network is updated.

Also, the predication accuracy of the neural network may be improved through more accurate revision thereof.

Also, the loss value is calculated by considering similar data belonging to the same kind of class as an anchor sample as a positive sample of the anchor sample, whereby the neural network may be updated more accurately.

According to the present disclosure, a loss value is calculated by reflecting not only a data sample generated from an anchor sample but also a similar data sample belonging to the same kind of class as the anchor sample, whereby accuracy may be improved when a neural network is updated.

Also, the present disclosure may improve the prediction accuracy of a neural network through more accurate revision thereof.

Also, the present disclosure calculates a loss value by considering similar data belonging to the same kind of class as an anchor sample as positive data, thereby performing more accurate update of a neural network.

As described above, the method for contrastive learning of a neural network for automatic data labeling and the apparatus for the same according to the present disclosure are not limitedly applied to the configurations and operations of the above-described embodiments, but all or some of the embodiments may be selectively combined and configured, so the embodiments may be modified in various ways.

What is claimed is:

1. A method for contrastive learning of a neural network, comprising:
generating transformed data samples for unlabeled input data samples corresponding to a batch size;
detecting a positive sample (positive data) in the transformed data samples in consideration of a similarity between a single data sample for contrastive learning, among the input data samples, and each of the transformed data samples; and
performing contrastive learning of a neural network based on a loss value of the positive sample.

2. The method of claim 1, wherein a transformed data sample, a cosine similarity of which with the single data sample is equal to or greater than a preset reference value, is detected as the positive sample.

3. The method of claim 2, wherein the positive sample also includes a transformed data sample belonging to a same kind of class as the single data sample depending on the cosine similarity.

4. The method of claim 3, wherein a transformed data sample belonging to the same kind of class as the single data sample and having the cosine similarity equal to or greater than the preset reference value is classified as the positive sample.

5. The method of claim 3, wherein, when a data sample is a transformed data sample for the single data sample but has the cosine similarity less than the preset reference value, the data sample is classified as a negative sample (negative data).

6. The method of claim 2, wherein, as the preset reference value for the cosine similarity is lower, more positive samples are detected, and as the preset reference value for the cosine similarity is higher, less positive samples are detected.

7. The method of claim 1, wherein a total loss value is calculated based on the loss value of the positive sample, and the neural network is updated by setting weights of the neural network so as to minimize the total loss value.

8. An apparatus for contrastive learning of a neural network, comprising:
a processor for generating transformed data samples for unlabeled input data samples corresponding to a batch size, detecting a positive sample (positive data) in the transformed data samples in consideration of a similarity between a single data sample for contrastive learning, among the input data samples, and each of the transformed data samples, and performing contrastive learning of a neural network based on a loss value of the positive sample; and
memory for storing the neural network.

9. The apparatus of claim 8, wherein the processor detects a transformed data sample, a cosine similarity of which with the single data sample is equal to or greater than a preset reference value, as the positive sample.

10. The apparatus of claim 9, wherein the positive sample also includes a transformed data sample belonging to a same kind of class as the single data sample depending on the cosine similarity.

11. The apparatus of claim 10, wherein the processor classifies a transformed data sample belonging to the same kind of class as the single data sample and having the cosine similarity equal to or greater than the preset reference value as the positive sample.

12. The apparatus of claim 10, wherein, when a data sample is a transformed data sample for the single data sample but has the cosine similarity less than the preset reference value, the processor classifies the data sample as a negative sample (negative data).

13. The apparatus of claim 9, wherein, as the preset reference value for the cosine similarity is lower, more positive samples are detected, and as the preset reference value for the cosine similarity is higher, less positive samples are detected.

14. The apparatus of claim 8, wherein the processor calculates a total loss value based on the loss value of the positive sample and updates the neural network by setting weights of the neural network so as to minimize the total loss value.
